(19) United States
(12) Patent Application Publication
(10) Pub. No.: US 2007/0244714 A1
(43) Pub. Date: Oct. 18, 2007

(54) Reducing Cost and Improving Quality of Health Care Through Analysis of Medical Condition Claim Data

(75) Inventors: Mary McCluskey, Coventry, CT (US); Catherine Gobes, West Hartford, CT (US); Nancy Taylor Ross, Southington, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna, Inc., Hartford, CT (US)

(21) Appl. No.: 11/279,504

(22) Filed: Apr. 12, 2006

(51) Int. Cl. G06Q 10/00; G06Q 40/00; H04M 3/51

(52) U.S. Cl. 705/2; 705/4; 705/11

(57) ABSTRACT

Techniques are disclosed for identifying opportunities for saving costs and increasing quality of health care. Claim information is organized according to an associated medical condition. A team focused on one major practice category uses historical claim data to identify particularly costly conditions within the major practice category. Additional research is performed with respect to that condition by constructing detailed data requests and reviewing recent literature, publications and news from real and virtual libraries. Using the research and additional data, opportunities are formulated and given to functional work teams to implement in one or more of a variety of ways.

### FIELD OF THE INVENTION

This invention relates generally to the field of health insurance and more specifically to the area of analyzing claim information.

### BACKGROUND OF THE INVENTION

In recent years, the cost of health insurance has increased dramatically. Although the cost of covered services no doubt has played a part in this trend, other contributing factors include missed opportunities for savings on the part of health plan organizations that pay for the covered services. For example, a health plan organization may routinely pay for types of services that are provided at a hospital when those services could equally have been provided at a less costly outpatient facility.

Claim data submitted by patients or providers to health plan organizations generally have included basic information such as name of patient, name of provider, site of service, date of service, diagnosis code and procedure code. As a result, previous analysis systems have focused on finding opportunities for cost savings according to these types of information, such as by investigating claim data on a provider-by-provider basis to see which providers are more efficient than others, or by comparing costs of services provided at a hospital that could have equally been provided at a less expensive outpatient facility.

However, by using only such traditional axes for their analysis, health plan organizations may not have been able to uncover saving opportunities that may not fit entirely within one of these dimensions. That is, there could be potential opportunities for savings in categories that cut across multiple traditional analytical categories, but cannot be identified by existing analytical techniques. Furthermore, the traditional techniques used for identifying cost saving opportunities have not traditionally been applied to fully uncover opportunities for increasing the quality of health care provided to patients.

### BRIEF SUMMARY OF THE INVENTION

In one aspect of the invention, a method is provided for decreasing costs of medical services or increasing quality of care provided to customers of a health plan organization, the costs of the health plan organization including payments for health care services provided to the customers according to submitted claims, and the method comprising identifying one medical condition for which the health plan organization has had a high cost over a given time period from a plurality of medical conditions within a first major practice category, specifying criteria to be used for searching a database of claim information, the criteria associated with the identified medical condition and comprising one or more procedure codes. one or more diagnosis codes and site of service indicia, searching the database and obtaining claim information according to the specified criteria and corresponding to the identified condition, retrieving industry information or health plan information associated with the identified condition to obtain one or more of innovation information, best practice information or health plan policy information, and correlating the innovation information, best practice information or health plan policy information to the obtained claim information to identify an opportunity to decrease cost or improve quality of care with respect to the identified condition.

In another aspect, a method for promoting efficiency and quality of medical services provided by a plurality medical service providers participating in a health plan organization and providing services within a major practice category, the costs of the health plan organization including payments for health care services provided to the customers according to submitted claims, and the method comprising determining one or more quality metrics corresponding to services provided by the providers, determining one or more cost efficiency metrics corresponding to services provided by the providers, determining one or more quality threshold levels according to the one or more quality metrics, determining one or more cost threshold levels according to the one or more cost metrics, identifying a provider in the plurality of providers that has surpassed the quality and cost threshold levels, and providing a preferential benefit to the provider.

In still another aspect of the invention, a system is provided for decreasing costs of medical services or increasing quality of care provided to customers of a health plan organization, the costs of the health plan organization including payments for health care services provided to the customers according to submitted claims, and the system comprising a team corresponding to a major practice category and comprising a lead member trained in one of the medical arts, a database of medical claim history, one or more reports produced using the database and organized by medical conditions within the major practice category, and an assemblage of one or more of best practice information, innovation information and health plan policy information, wherein at least one of the reports is made available to the team in order to facilitate identification of a medical condition for investigation, and wherein the database, reports and assemblage are made available to the team in order to facilitate identification of cost-saving or quality-increasing opportunities.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a diagram of a system used to identify cost-saving and quality-increasing opportunities by a health plan organization, in accordance with an embodiment of the invention;

FIG. 2 is a hierarchical diagram of a claim data structure as used by a system for identifying cost-saving and quality-increasing opportunities by a health plan organization, in accordance with an embodiment of the invention;

FIG. 3 is a diagram illustrating an example of a major practice category team, in accordance with an embodiment of the invention; and

FIG. 4 is a flow diagram of a technique for identifying cost-saving and quality-increasing opportunities, in accordance with an embodiment of the invention.

### DETAILED DESCRIPTION OF THE INVENTION

The following examples further illustrate the invention but, of course, should not be construed as in any way limiting its scope.

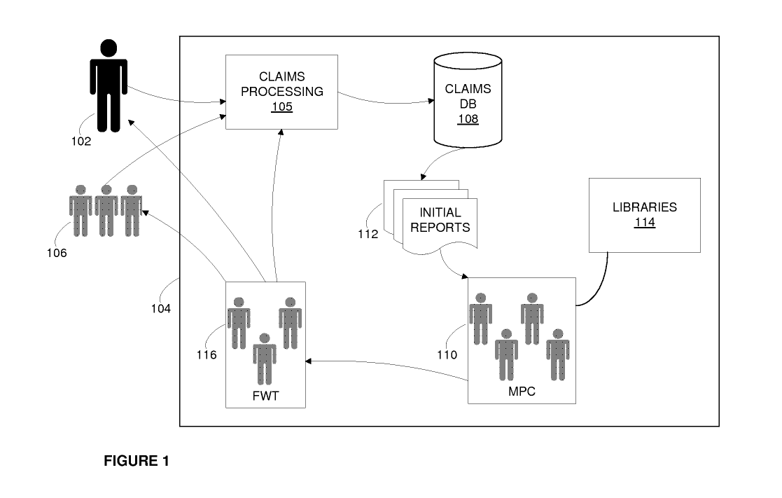

Turning to FIG. 1, an implementation of a system contemplated by an embodiment of the invention is shown with reference to an overall healthcare claims analysis environment. A patient 102 subscribes to a health plan of a health plan organization (“HPO”) 104. The HPO is typically a health insurance company and the health plan can be one of a number of health insurance or related products, such as a PPO, HMO, POS, or the like. The health plan can also be a self-insured program funded by, for example, the patient's 102 employer and serviced by the HPO. The subscriber's plan covers various health care services according to one of a variety of pre-arranged terms. The terms can vary greatly from plan to plan according to: what types of services are provided, where the services are provided, by whom they are provided, the extent to which the patient is personally responsible for payment, amount of deductibles, etc. Generally, however, regardless of the specific plan subscribed to, when a patient 102 obtains health care services from a provider 106, either the patient 102 or the provider 106 can submit a claim to the HPO 104 for reimbursement or payment. The claim is typically processed by a claims processing department 105, and an appropriate reimbursement/payment is made or denied accordingly. For analysis purposes, historical claim data is stored in a claims database 108. By querying the database 108, users can generate reports according to selected criteria that will allow them to see financial information such as how much money has been spent for particular kinds of submitted claims.

In an embodiment of the invention, analysis is performed by a team 110 of individuals assigned to a major practice category (“MPC”). The MPC team 110 is responsible for one of approximately twenty MPCs comprising the following medical areas: neonatology, neurology, endocrinology, ENT, women's services, infections diseases, rheumatology, orthopedics, oncology, hematology, cardiology, dermatology, gastroenterology, nephrology, pulmonary, psychiatry, urology and preventative medicine. Of course, other categories are possible if desired. The MPC team 110 receives a set of initial reports 112 for analysis generated from the claims database 108. The reports 112 are preferably restricted to include claim information regarding those claims associated with the team's 110 particular MPC. Furthermore, the reports 112 are preferably organized by medical condition, as described below. The MPC team 110 also can request additional reports to be created from the claims database 108 for particular research purposes. The MPC team 110 also has access to both real and virtual libraries 114. The libraries 114 preferably contain information regarding best practices, recent innovations, current research and technological advances in particular medical and industry areas relevant to the medical areas of MPC team 110. The libraries further preferably contain information regarding health plans offered by the HPO 104, such as policy and coverage information in the form of clinical policy bulletins describing, for example, the extent to which various types of services may be covered under one of the HPO's plans in terms of whether particular services are “medically necessary”, “experimental”, etc. By interacting with the claims database 108 and the libraries 114, and by leveraging the knowledge of its individual members, as described below, the MPC team 110 can uncover opportunities for cost savings and for quality improvement.

Once the MPC team 110 has determined an opportunity exists to save cost or improve health care quality, it preferably notifies a functional working team (“FWT”) 116 in order to implement a plan to seize the opportunity. The FWT 116 is one of several FWTs, each responsible for one of a group of functional areas, including: claims handling, special investigations, policy, fee schedules within the HPO network, case management and pre-certification. The FWT 116 ensures that necessary actions are taken in order to effectuate the opportunity. Such changes vary from FWT to FWT, but could include, for example: adjusting whether certain procedures are covered under a health plan; varying the amount which providers are compensated for particular services; increasing the amount of coverage for patients taking identified preventative health measures; creating educational programs for providers and/or patients on particular topics; etc.

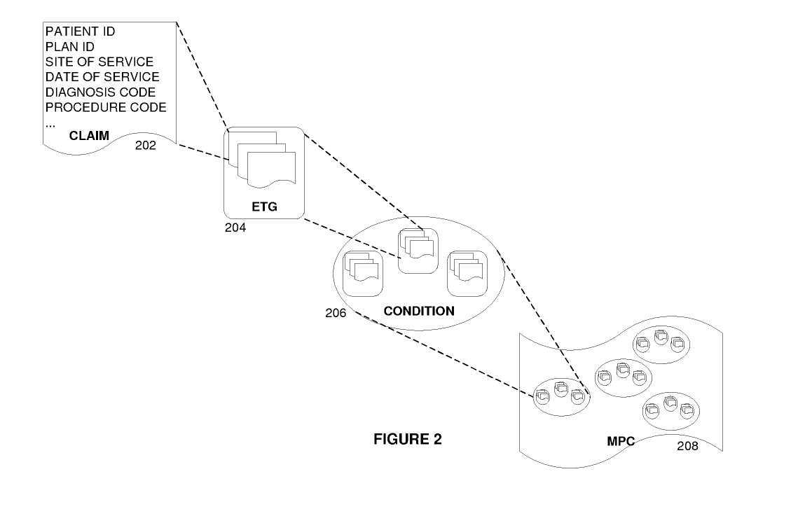

Turning attention to FIG. 2, a hierarchical organization of data is shown for analyzing health care claim information by condition, in accordance with an embodiment of the invention. When a HPO subscriber visits a health care provider for services, he or the provider can submit a claim 202 to the HPO for payment. Minimally, the claim 202 contains sufficient information to identify the patient and the subscribed-to plan under which the claim is being submitted. The claim 202 also generally includes indicia as to the site of service (e.g., identifying a doctor's office or a hospital) and the date(s) on which the services were performed. The claim 202 also generally includes indicia as to the nature of the services performed and the nature of the patient's diagnosis. These indicia are preferably submitted in the form of standardized codes, such as CPT-4 and ICD-9. Additionally or alternatively, claim information may include indicia as to pharmaceutical prescription fulfillment.

While claims submitted in this form may suffice to process them for payment, additional organization of the data is useful for analyzing an aggregation of claim information for cost-saving and quality-increasing purposes. To this end, embodiments of the invention group claims into instances of episode treatment groups (“ETGs”) 204 according to whether the claims arise out of the same episode. For example, multiple claims are often submitted when a patient undergoes surgery at a hospital: one claim on behalf of the surgeon for the surgery itself, and one claim on behalf of the hospital. Because these claims stem from the same episode, they are combined into a single ETG instance 204 for analysis purposes. Furthermore, the ETG instance 204 can span over time to include post-procedure claims (for example, for physical therapy needed as a result of the surgery) or pre-procedure claims (for example, for diagnostic evaluations and consultations leading into the surgery). An ETG instance 204 can also include apparently similar claims over a time period, such as a patient's multiple visits to a chiropractor for relief a back ailment. After some determined claim-free period, the ETG instance 204 can be closed. An ETG instance 204 can also include claims from different places of service, and pharmaceutical use. There are approximately 500 different types of ETGs into which a particular ETG instance may fall. ETGs are described more fully in “Episode Treatment Groups: An Illness Classification and Episode Building System”, found at http://www.symmetry-health.com/ETGTut_Desc1.htm, which is hereby incorporated by reference for all that it teaches without exclusion to any part thereof.

Embodiments of the invention further facilitate the analysis of claim information by classifying ETGs according to medical condition 206. Thus, a single condition 206, such as prostate cancer, preferably includes all known ETG instances pertaining to that malady. Each ETG instance so classified may appear very different from one another, but all share the common thread of being related to a patient's condition of prostate cancer. Notably, not every claim within the ETGs so classified need contain a diagnosis code corresponding to prostate cancer: for example, a claim submitted for service related to a medical side effect of a drug may contain a different diagnosis code, but will nevertheless be associated with the appropriate ETG 204 and condition 206. A finite set of non-overlapping conditions is preferably enumerated at the outset so that each ETG instance is placed into exactly one condition.

In order to still further facilitate the analysis of claim information, conditions are categorized by MPC 208 in an embodiment of the invention. As described above, each MPC 208 represents a defined area within the practice of health care. A team for an MPC 208 reviews claim data corresponding to conditions within the MPC 208 in order to identify opportunities for saving costs and increasing the quality of health care within the MPC 208. Although an MPC team may find such an opportunity within their designated MPC, the opportunity may nevertheless be applicable outside their designated MPC as well. For example, if an MPC team finds that certain costly billing errors are routinely committed by hospitals with respect to one condition, it may very well be that similar billing errors are committed with respect to other conditions and within other MPCs. Sharing of discovered opportunities is therefore performed in embodiments of the invention.

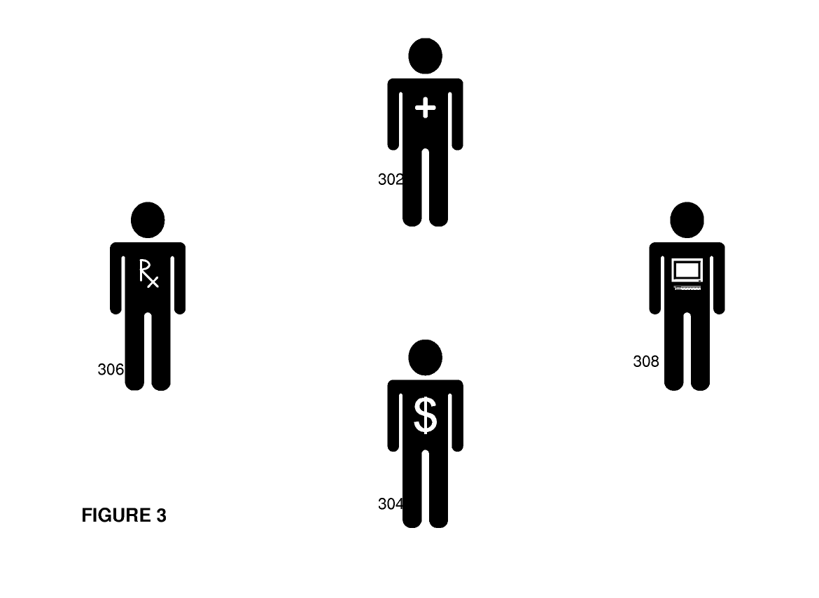

A sample MPC team, as used in an embodiment of the invention, is now described with respect to FIG. 3. The MPC team generally includes a clinical lead member 302 who is a trained health care provider, such as a medical doctor, familiar with procedures and practices within the MPC. The clinical lead 302 is uniquely able to identify potentially innovative opportunities by staying abreast of emerging health technologies via journals, conferences, articles or other resources available through the HPO real or virtual libraries 114. Additionally, the MPC team preferably includes an actuary 304 for evaluating the impact of recommendations for pricing, or for assessing the financial impact of medical trends. The MPC team also preferably includes a member 306 familiar with the pharmaceutical industry and regulatory matters. This member 306 identifies emerging pharmaceutical technology and helps analyze pharmaceutical spending associated with given conditions in the MPC. Additionally, the MPC team preferably includes one or more members 308 familiar with the claims database and other databases available to the team, in order to facilitate requests for data to be used by the team in evaluating opportunities. Additional members may be included in the MPC team, such as members familiar with regional variances or members specifically focused on administering the process.

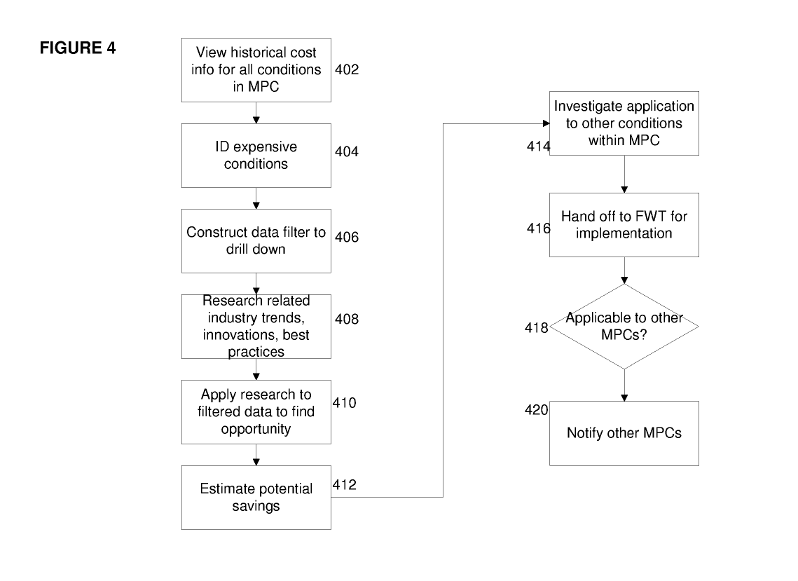

Turning to FIG. 4, a process is described by which an MPC team identifies an opportunity to reduce the costs spent on health care services or to increase the quality of health care, in accordance with an embodiment of the invention. Initially, at step 402 the MPC team receives one or more reports generated from historical claim information contained in a claim database. The reports are particular for the MPC and are organized by conditions within the MPC. Additionally, the reports are preferably broken down for each condition across cost categories, such as inpatient, emergency, primary physician, lab work, average cost per episode, variability of cost per episode, etc. Thus, looking at the reports, the MPC team members can determine at step 404 which particular conditions resulted in high expenditures of funds. Once expensive conditions have been identified, the MPC team can focus its efforts on these identified conditions and drill down for additional claim information that may be of interest in identifying specific opportunities by constructing data extracts and filters to be used with the claims database at step 406. The team, particularly the clinical lead, researches industry trends, best practices and technological innovations at step 408. Additionally or alternatively, the team researches the HPO's health plan information, such as policy and coverage information. Applying this research to the drilled-down data, the MPC team can formulate particular opportunities at 410, and estimate the potential cost savings and health quality improvements at step 412. Furthermore, the team investigates at step 414 if the opportunity can be applied to other conditions; although the opportunity may have originally been investigated with respect to only one of the conditions within the MPC, it nevertheless may be applicable to additional conditions within the MPC. Once the opportunity has been established and evaluated, it is handed off to one or more functional work teams at step 416 for implementation through the appropriate channels. The team also evaluates at step 418 whether the opportunity may be applicable to other MPCs. If so, the appropriate MPC teams are notified at step 420.

One example of the process of FIG. 4 is now described. Using the initial reports, the appropriate MPC team finds that “low back pain” was the condition for which the greatest amount was spent over a recent historical period within the MPC. The MPC team drills down in greater detail by constructing data filters to see more specifically where money has been spent for the condition of low back pain. It finds that one of the more expensive areas was epidural injections used during low back pain surgery. After researching medical bulletins and journals, the clinical lead of the MPC team finds that there was no evidence to support the use of monitored anesthesia with such an epidural. The MPC team drills further with data filters on the claims database to research how much had been spent on monitored anesthesia care for epidurals associated with low back pain. Because the amount is significantly high, a proposal is made to a functional work team to adjust policies to remove coverage for such unnecessary anesthesia care. Additionally, other MPCs are notified of the idea of looking for cost-reduction opportunities with respect to monitored anesthesia and epidurals. Without the above-described process, the identification of this opportunity is significantly more difficult. Since there are other conditions within other practice areas where monitored anesthesia care is appropriate, this opportunity would not readily present itself through more traditional methods of analyzing medical claim data, such as by provider or by procedure.

As an additional feature, embodiments of the invention promote efficiency and quality of medical services when used as the basis for or in conjunction with a tiered-provider network. For example, the HPO can establish quality and cost metrics for various procedures or the treatment of various conditions performed by participating providers within a MPC. The HPO can further establish one or more tiers of threshold levels for these metrics and evaluate providers' performance accordingly. Providers can then be categorized based on the threshold levels they achieve. Those providers who have met the higher thresholds can be rewarded, either directly (by, for example, a preferred payment rate by the HPO), or indirectly (by, for example, recommending those providers to HPO customers, or providing extra benefits to customers of those providers in the form of increased percentage of coverage, reduced co-payments, or other benefits). In embodiments of the invention, opportunities identified by the methods described above can be used to establish the metrics and thresholds. For example, if it was determined through the above-described method that monitored anesthesia care should not be used during certain procedures, whether a provider performs any of those procedures with monitored anesthesia can be used as a factor in a quality or cost metric.

Embodiments of the invention further involve the creation of utilization metrics, by which sub-groups within the HPO (e.g., regions) can identify particular opportunities for saving costs or increasing quality.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-12. (canceled)

14-37. (canceled)

38. A method for decreasing costs of medical services or increasing quality of care provided to customers of a health plan organization, the costs of the health plan organization including payments for health care services provided to the customers according to submitted claims, and the method comprising:
identifying one medical condition for which the health plan organization has had a high cost over a given time period from a plurality of medical conditions within a first major practice category;
specifying criteria to be used for searching a database of claim information, the criteria associated with the identified medical condition and comprising:
one or more procedure codes;
one or more diagnosis codes; and
site of service indicia;
searching the database and obtaining claim information according to the specified criteria and corresponding to the identified condition;
retrieving industry information or health plan information associated with the identified condition to obtain one or more of innovation information, best practice information or health plan policy information; and
correlating the innovation information, best practice information or health plan policy information to the obtained claim information to identify an opportunity to decrease cost or improve quality of care with respect to the identified condition.

39. The method of claim 38 wherein the identified opportunity comprises saving costs by modifying the manner in which claims are processed.

40. The method of claim 38 wherein the identified opportunity comprises saving costs by modifying the amount to be paid by the health plan organization for one or more types of services provided by one or more providers.

41. The method of claim 38 wherein the identified opportunity comprises saving costs by modifying the manner in which claims are processed according to the identified opportunity.

42. The method of claim 38 wherein the identified opportunity comprises saving costs by modifying the manner in which potentially fraudulent practices are investigated.

43. The method of claim 38 wherein the identified opportunity comprises saving costs by requiring pre-certification for one or more types of medical services.

44. The method of claim 38 wherein the identified opportunity comprises saving costs by educating health care providers as to more efficient processes.

45. The method of claim 38 further comprising the step of providing a financial incentive to providers for adopting the identified opportunity.

46. The method of claim 38 wherein the identified opportunity comprises improving quality of care by initiating one or more educational programs to customers.

47. The method of claim 38 wherein the identified opportunity comprises improving quality of care by encouraging providers to perform services identified as leading to better results.

48. The method of claim 38 wherein the identified opportunity comprises improving quality of care by initiating one or more educational programs to providers.

49. The method of claim 38 wherein the identified opportunity comprises improving quality of care by informing providers of recent innovations.

50. The method of claim 38 wherein costs for the identified medical condition are represented within one or more episode treatment groups.

51. The method of claim 38 further comprising investigating whether the identified opportunity can be applied to decrease cost or improve quality of care with respect to a second condition.

52. The method of claim 38 further comprising investigating whether the identified opportunity can be applied to decrease cost or improve quality of care with respect to a second major practice category.

53. The method of claim 38 wherein the method is performed by a team corresponding to the first major practice category and including a lead member with training in the medical arts.

54. The method of claim 38 further comprising providing an efficiency rating for one or more providers according to the provider's implementation of the identified opportunity.

55. A method for promoting efficiency and quality of medical services provided by a plurality medical service providers participating in a health plan organization and providing services within a major practice category, the costs of the health plan organization including payments for health care services provided to the customers according to submitted claims, and the method comprising:
determining one or more quality metrics corresponding to services provided by the providers;
determining one or more cost efficiency metrics corresponding to services provided by the providers;
determining one or more quality threshold levels according to the one or more quality metrics;
determining one or more cost threshold levels according to the one or more cost metrics;
identifying a provider in the plurality of providers that has surpassed the quality and cost threshold levels; and
providing a preferential benefit to the provider.

56. The method of claim 55 wherein one or more of the quality or cost metrics is determined by:
identifying one medical condition for which the health plan organization has had a high cost over a given time period from a plurality of medical conditions within the major practice category;
specifying criteria to be used for searching a database of claim information, the criteria associated with the identified medical condition:
searching the database and obtaining claim information according to the specified criteria and corresponding to the identified condition;
retrieving industry information or health plan information associated with the identified condition to obtain one or more of innovation information, best practice information or health plan policy information; and
correlating the innovation information, best practice information or health plan policy information to the obtained claim information to identify an opportunity to decrease cost or improve quality of care with respect to the identified condition.

57. The method of claim 55 wherein the preferential benefit is recommending the identified provider to customers subscribing to the health plan organization.

58. The method of claim 55 wherein the preferential benefit is increasing the percentage of the HPO's payment coverage for customers of the provider.

59. The method of claim 55 wherein the preferential benefit is reducing the amount of co-payment required from a customer of the provider.

60. The method of claim 55 wherein the preferential benefit is increasing the compensation made from the HPO to the provider.

61. A system for decreasing costs of medical services or increasing quality of care provided to customers of a health plan organization, the costs of the health plan organization including payments for health care services provided to the customers according to submitted claims, and the system comprising:
a team corresponding to a major practice category and comprising a lead member trained in one of the medical arts;
a database of medical claim history;
one or more reports produced using the database and organized by medical conditions within the major practice category; and
an assemblage of one or more of best practice information, innovation information and health plan policy information;
wherein at least one of the reports is made available to the team in order to facilitate identification of a medical condition for investigation, and wherein the database, reports and assemblage are made available to the team in order to facilitate identification of cost-saving or quality-increasing opportunities.

62. The system of claim 61 further comprising a functional working team for facilitating implementation of the identified opportunities.

63. The system of claim 62 wherein the functional working team facilitates implementation of an identified cost-saving opportunity by modifying the manner in which claims are processed.

64. The system of claim 62 wherein the functional working team facilitates implementation of an identified cost-saving opportunity by modifying the amount to be paid by the health plan organization for one or more types of services provided by one or more providers.

65. The system of claim 62 wherein the functional working team facilitates implementation of an identified cost-saving opportunity by modifying the extent to which one or more types of services will receive payment under a health plan.

66. The system of claim 62 wherein the functional working team facilitates implementation of an identified cost-saving opportunity by modifying the manner in which claims are processed.

67. The system of claim 62 wherein the functional working team facilitates implementation of an identified cost-saving opportunity by modifying the manner in which potentially fraudulent practices are investigated.

68. The system of claim 62 wherein the functional working team facilitates implementation of an identified cost-saving opportunity by requiring pre-certification for one or more types of medical services.

69. The system of claim 62 wherein the functional working team facilitates implementation of an identified cost-saving opportunity by educating health care providers as to more efficient processes.

70. The system of claim 62 wherein the functional working team facilitates implementation of an identified quality-increasing opportunity by initiating one or more educational programs to customers.

71. The system of claim 62 wherein the functional working team facilitates implementation of an identified quality-increasing opportunity by initiating one or more educational programs to providers.

72. The system of claim 62 wherein the functional working team facilitates implementation of an identified quality-increasing opportunity by informing providers of recent innovations.

73. The system of claim 62 wherein the functional working team facilitates implementation of an identified quality-increasing opportunity by encouraging providers to perform services identified as leading to better results.
